(19) United States
(12) Patent Application Publication
(10) Pub. No.: US 2018/0018908 A1
(43) Pub. Date: Jan. 18, 2018

(54) DOUBLE SIGNS COMPRISING A THICK SUPPORT

(71) Applicant: Patrick RUBINSTEIN, Paris (FR)

(72) Inventor: Patrick RUBINSTEIN, Paris (FR)

(21) Appl. No.: 15/647,426

(22) Filed: Jul. 12, 2017

(30) Foreign Application Priority Data
Jul. 18, 2016 (FR) 16 70390

(51) Int. Cl. G09F 19/14

(52) U.S. Cl. CPC G09F 19/14

(57) ABSTRACT

A dual display comprising a front face in the form of an undulating sheet (9; 9′), that has a succession of troughs (6) and ridges (7), the left-hand sides (4) of the undulation turned to the left comprising a succession of sub-images, photographs, drawings or the like intended to form together an image, photograph, drawing or the like to be seen from the left, and the right-hand sides (5) comprising a succession of sub-images, photographs, drawings or the like intended to form together an image, photograph, drawing or the like to be seen from the right, and a support element (1) to which is fixed the undulating sheet (9; 9′), in particular by sticking, characterised in that the support element (1) is in the form of a block that has an undulating outer face of a form that complements the form of the undulating sheet and an inner face, the sheet (9; 9′) being fixed to the outer undulating face of the block and, measured in the direction perpendicular to the front sheet (9; 9′), the thickness (E) of the support element at the level of the trough the furthest away from the inner face is greater than or equal to half the smallest distance (e) between two successive troughs and ridges.

### TECHNICAL FIELD

The present invention relates to a device that forms a dual display, i.e., a display that shows two images, drawings, patterns or the like, one that is seen when one is positioned to the left of the display, and the other when one is positioned to the right of the display.

### BACKGROUND ART

Traditionally, this type of dual display or board comprises a front sheet to which images, patterns, photographs or the like have been affixed, drawn or similarly formed in the form of strips, the strips corresponding to the image to be seen from the left alternating with the strips corresponding to the image to be seen from the right. Furthermore, this front sheet is folded in order to have an undulating form that comprises troughs and ridges, the left sides extending between one ridge and one trough on the left side corresponding to the image intended to be seen from the left, and the right sides extending between one ridge and one trough on the right side corresponding to the image intended to be seen from the right. It is also known to add a rear support plate to which the front sheet is fixed at the level of the troughs of the sheet.

These displays from the prior art are complicated to produce since they require manual production, in particular due to the necessity to position the sheet appropriately on the support, in particular by sticking along the troughs. On the other hand, they are either very heavy in order to have good stability, in particular by providing plates made of heavy material such as steel or some other metal, or they have poor structural resistance.

### SUMMARY OF THE INVENTION

The object of the present invention is to overcome the disadvantages of the prior art by making available a dual display of the aforementioned type which is both simple to produce and which has a resistant structure, while at the same time being of moderate weight.

According to the invention, the dual display is as defined in claim 1, improvements and preferred embodiments being defined in the sub-claims.

### BRIEF DESCRIPTION OF THE DRAWINGS

As an example one will now describe a preferred embodiment of the invention by making reference to the drawings in which:

FIG. 1 is a sectional view of a dual display according to an embodiment of the invention;

FIG. 2 is a sectional view identical to FIG. 1 of a second embodiment of the invention; and

FIG. 3 is a sectional view of the sheet that forms the face of the embodiment of FIG. 2.

### PREFERRED EMBODIMENT FOR CARRYING OUT THE INVENTION

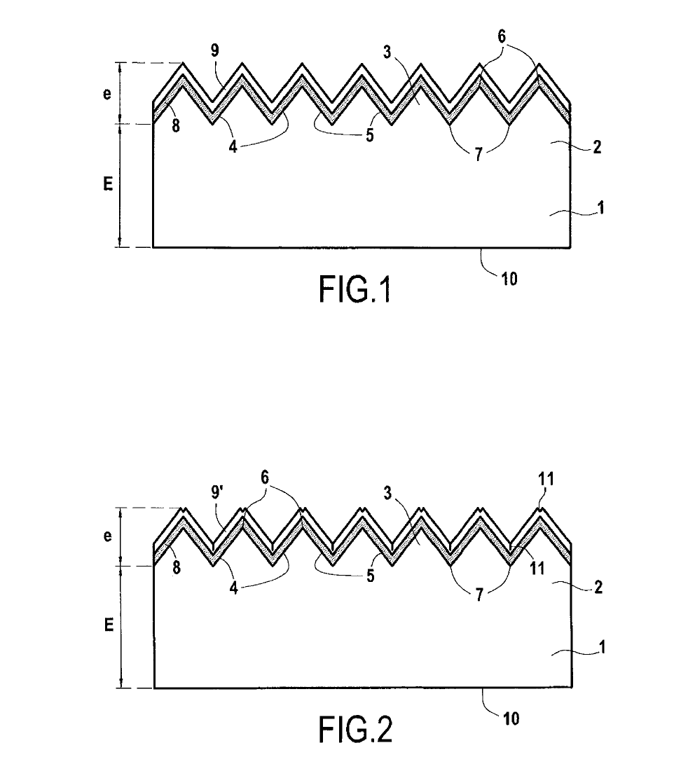

FIG. 1 shows a first embodiment of the invention. The dual display is made up of a support element 1 in the form of a block comprising a base part 2 in the form of a rectangular plate ending in longitudinal ribs 3 with a triangular cross-section which respectively define alternating successions of left-hand faces or sides 4 and right-hand faces or sides 5. In section, and as can be seen in FIG. 1, the ribs 3 of the support element 1 thus define an undulating form made up of successive ridges 6 and troughs 7 that separate the left 4 and the right 5 sides.

Each ridge 6 separates two successive respectively left 4 and right 5 sides, whereas each trough 7 separates two successive respectively right 5 and left 4 sides. It is placed over the front or outer face (upper face in the figure) of the support element 1, with the interposition of a layer 8 of adhesive, a sheet 9 forming the front face of the display, in particular made of cardboard or with a grammage greater than 60 g/m², preferably greater than 220 g/m², which comprises a succession of alternatively left-hand and right-hand sub-images. The left-hand sub-images are intended to be located opposite the left-hand sides 4, whereas the right-hand sub-images are intended to be located opposite the right-hand sides 5. When one looks at the panel in its entirety from the left, all of the left-hand sub-images of the sheet 9 form a left-hand image.

When one looks at the panel from the right, all of the right-hand sub-images of the sheet form a right-hand image which may in particular be different from the left-hand image.

As can be seen from the figure, located between the rectangular base plate 2 and the front sheet 9 are the triangular ribs such that there is no void between the rectangular base plate 2 and the sheet 9.

Furthermore, as measured in the direction perpendicular to the plane of the inner flat surface 10 of the base plate 2 of the block 1 (this is also the direction substantially perpendicular to the front face, along the bisection between the two directions seen from the left and the right), the thickness of the base plate 2, namely the distance E between the inner flat surface 10 and the trough the furthest away from the latter (in the embodiments shown, the troughs 6 are all the same distance away from the inner flat surface 10), is greater than or equal to half the distance e between the two successive ridges and troughs that are closest to one another (in the embodiments shown, the distances between two successive ridges and troughs are all identical), preferably greater than the distance e, in particular greater than 2e.

The block forming the support element 1 is fixed to the rear surface of the sheet 9 over at least half of this surface, preferably at least 70%, even more preferably at least 80%, in particular at least 90%, in particular over substantially the entire surface, even more particularly over the entire rear surface.

In particular, when the sheet and the block are rectangular in form, the height of the block is at least equal to 50% of the height of the sheet, preferably at least 70%, even more preferably at least 80%, in particular at least 90%, in particular is equal to the height of the sheet.

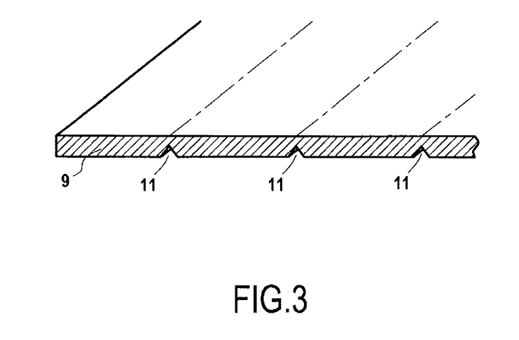

As shown in FIGS. 2 and 3, provision may be made such that the sheet 9′ comprises ribs 11 at the level of the troughs 6 and the ridges 7, in particular triangular in form, the ribs in particular being turned towards the front.

The block (support element 1) is in particular made of polystyrene, in particular of crystal polystyrene (PS), expanded polystyrene (PSE), extruded polystyrene (PSE), in particular with closed cells, or of so-called high impact polystyrene (SB, HIPS). However, other plastic materials, thermoplastics or thermosetting plastics that have similar properties may be used to produce the block.

In particular, and advantageously, according to the invention the support element of the sheet may comprise purely the block.

What is claimed is:

1. A dual display comprising a front face in the form of an undulating sheet (9; 9′) that has a succession of troughs (6) and ridges (7), the left-hand sides (4) of the undulation turned to the left comprising a succession of sub-images, photographs, drawings or the like intended to form together an image, photograph, drawing or the like to be seen from the left, and the right-hand sides (5) comprising a succession of sub-images, photographs, drawings or the like intended to form together an image, photograph, drawing or the like to be seen from the right, and a support element (1) fixed to the rear surface of the undulating sheet (9; 9′), in particular by sticking, characterised in that
the support element (1) is in the form of a block that has an undulating outer face of a form that complements the form of the undulating sheet and an inner face, the sheet (9; 9′) being fixed to the outer undulating face of the block and, measured in the direction perpendicular to the front sheet (9; 9′), the thickness (E) of the support element at the level of the trough the furthest away from the inner face is greater than or equal to half the smallest distance (e) between two successive troughs and ridges;
the block being made of a plastic material; and
the height and width dimensions of the block are such that the support element in the form of a block covers at least half of the rear surface of the sheet.

2. The display according to claim 1, characterised in that the support element in the form of a block covers the entire rear surface of the sheet.

3. The display according to claim 1, characterised in that the plastic material is a polystyrene.

4. The display according to claim 1, characterised in that the sheet is fixed to the support element such that no space remains between the support element (1) and the sheet (9; 9′).

5. The display according to claim 1, characterised in that the fixing is implemented by a layer (8) of adhesive.

6. The display according to claim 3, characterised in that the support element (1) is produced from expanded polystyrene (PSE).

7. The display according to claim 3, characterised in that the support element (1) is produced from extruded polystyrene.

8. The display according to claim 1, characterised in that the thickness (E) is greater than or equal to the distance (e).

9. The display according to claim 1, characterised in that the sheet is made of a substantially rigid material, in particular cardboard, in particular with a thickness greater than 60 g/m².

10. The display according to claim 1, characterised in that the sheet (9′) comprises ribs (11), formed in particular on the side opposite the block (1), in particular ribs formed along the troughs and the ridges.
